(19) United States
(12) Patent Application Publication
(10) Pub. No.: US 2014/0232343 A1
(43) Pub. Date: Aug. 21, 2014

(54) PORTABLE CHARGING APPARATUS

(71) Applicants: Oliver Tadd, Harlow (GB); Robert Kendrick, Sutton-in-Ashfield (GB)

(72) Inventors: Oliver Tadd, Harlow (GB); Robert Kendrick, Sutton-in-Ashfield (GB)

(73) Assignee: SANDAL PLC, Harlow, Essex (GB)

(21) Appl. No.: 14/127,510

(22) PCT Filed: Apr. 23, 2012
(86) PCT No.: PCT/GB2012/000376

§ 371 Date: May 7, 2014

(30) Foreign Application Priority Data
Jun. 22, 2011 (GB) 1110608.5

(51) Int. Cl. H02J 7/00

(52) U.S. Cl. CPC H02J 7/0044
USPC 320/114

(57) ABSTRACT

The present invention relates to portable charging apparatus suited for a handheld electronic device, a power supply for use in a portable charging device and a portable charging apparatus for recharging a handheld electronic device. In one embodiment, a portable charging apparatus for a handheld electronic device having a housing including an internal battery, the portable charging device comprising a power supply, an electrically conductive means for providing power from the power supply, and securing means for detachably securing the portable charging apparatus to the housing of the handheld electronic device, whereby in use the portable charging apparatus is secured to an outer surface of the housing of the handheld electronic device. Alternatively, a plug of the electrically conductive means can be moved into alignment with the charging port of the handheld electronic device before securing the power supply to the housing of the handheld electronic device. In another embodiment, a portable charging apparatus for a handheld electronic device is provided comprising a power supply means, a securing means for detachably securing the power supply means to a handheld electronic device; and a connector unit comprising an electrically conductive member having a first connector and a second connector for electrically connecting to the interface port of the power supply means, wherein the second connector is mountable on the power supply means such that the connector unit is movable relative to the power supply means.

### FIELD OF INVENTION

The present invention relates to portable charging apparatus suited for a handheld electronic device, and particularly a portable charging apparatus for recharging a handheld electronic device.

### BACKGROUND

Modern mobile telephones, personal digital assistants (PDAs) and other handheld electronic devices typically consume a large amount of power, particularly given the recent trend towards as increased display screen size, ‘always on’ wireless connectivity and handheld electronic devices increasingly being used as portable media players. Many devices of this type are also preferably as compact as possible and so necessarily require compact means of storing power. The result is that many modern handheld electronic devices incorporate a relatively small battery, which is only capable of providing power for a relatively short time. Such devices therefore suffer from a short battery life and consequently require frequent charging.

Typically a handheld electronic device is recharged by connecting it to a mains electrical supply directly via a power cable, or by placing it in a cradle which is in turn connected to a mains electrical supply. This type of charging is fundamentally incompatible with the mobile nature of these devices and further is subject to the availability of a mains electrical outlet.

Attempts have been made to address this problem of mobility by providing a portable power source that can be connected to a handheld electronic device in order to recharge it in situ. One such example is US Patent Application No. 2010 0,754,527 which discloses a portable cradle unit that features a battery and a built-in solar charger for use with a mobile telephone. The user places their mobile telephone inside the frame of cradle to allow it to connect to a battery contained therein in order to allow it to charge.

A problem with existing portable charging units of the type disclosed in US 2010 0,754,527 is that the charging cradle must necessarily be designed to accommodate the particular handheld electronic device for which it is designed to charge. The cradle is therefore limited for use only with this particular device, or in some cases family of devices. This lack of flexibility is not desirable given the many different types of handheld electronic device that exist today, each having a unique configuration of socket positions, control buttons, speakers, camera lenses and the like.

A further problem with portable charging units in general is that they can be cumbersome and hence discourage or even prevent the user from enjoying the full functionality of their device whilst it is being charged. In the case of a mobile telephone, for example, a portable cradle charger may prevent the user from gaining accessing to the microphone and/or speaker in order to make a telephone call whilst the device is charging. In another example, the position of the charging unit could prevent the user from inserting headphones into their device, precluding them from listening to music whilst the device is charging.

### SUMMARY

According to a first aspect, the present invention provides a portable charging apparatus for a handheld electronic device having a housing including an internal battery, the portable charging device comprising:
a power supply;
an electrically conductive means for providing power from the power supply, the electrically conductive means comprising a wire having a plug at a distal end for detachably connecting to a charging port of a handheld electronic device, wherein one or more channels are formed in the power supply and are arranged to accommodate the wire whilst the device is in use; and
securing means for detachably securing the portable charging apparatus to the housing of the handheld electronic device, whereby in use the portable charging apparatus is secured to an outer surface of the housing of the handheld electronic device.

From a second aspect, the present invention provides a portable charging apparatus for a handheld electronic device, comprising:
a power supply means having a power supply and at least one interface port providing an electrical connection to the power supply;
securing means for detachably securing the power supply means to a handheld electronic device; and
a connector unit comprising an electrically conductive member having a first connector for detachably electrically connecting to the handheld electronic device and a second connector for electrically connecting to the interface port of the power supply means;
wherein the second connector is mountable on the power supply means such that the connector unit is movable relative to the power supply means.

From a third aspect, the present invention provides a power supply for use in recharging a battery of a handheld electronic device, the power supply comprising an interface port on a major surface for receiving a connector, and means for securing the power supply to an outer surface of the handheld electronic device.

From a fourth aspect, the present invention provides a connector unit for use with the above-defined power supply means, the connector unit having a housing comprising: an electrically conductive means contained therein; and a plug electrically connected to the electrically conductive means and extending in a first direction from the housing, the plug adapted to detachably connect to an charging port of a handheld electronic device, wherein the plug is movable within the housing in at least a second direction transverse to the first direction.

From a fifth aspect, the present invention provides a handheld electronic device having a housing including an internal battery, the portable charging device comprising:
a power supply;
an electrically conductive means for providing power from the power supply, the electrically conductive means comprising a plug for detachably connecting to an charging port of a handheld electronic device; and
securing means for detachably securing the power supply to the housing of the handheld electronic device, wherein the plug is movable relative to the power supply such that, in use, the plug can be moved into alignment with the charging port of the handheld electronic device before securing the power supply to the housing of the handheld electronic device.

### BRIEF DESCRIPTION OF DRAWINGS

Embodiments of the invention are described below in more detail, by way of example, with reference to the accompanying drawings in which:

FIG. 1 shows a portable charging device according to a first embodiment of the present invention positioned on a first type of handset;

FIG. 2 shows a more detailed view of the connector unit and plug section of the portable charging device of FIG. 1;

FIG. 3 shows the portable charging device of FIG. 1 positioned on a second type of handset;

FIG. 4 shows a portable charging device according to a first embodiment of the present invention;

FIG. 5 shows a portable charging device according to a third embodiment of the present invention;

FIG. 6a shows a portable charging device according to a fourth embodiment of the present invention;

FIG. 6b is a side view of FIG. 6a;

FIG. 7a shows a portable charging device according to a fifth embodiment of the present invention;

FIG. 7b is a side view of FIG. 7a;

FIG. 7c shows the base of the portable charging unit of FIG. 7a;

FIG. 7d is a not-to-scale perspective view along section line A-A of FIG. 7c;

FIG. 7e shows a portable charging device according to a sixth embodiment of the present invention;

FIG. 8 shows an exploded view of a first exemplary means for securing the portable charging device of FIG. 1 to a handheld electronic device;

FIG. 9 shows a second exemplary means for securing the portable charging device of FIG. 1 to a handheld electronic device;

FIG. 10 shows a third exemplary means for securing the portable charging device to a handheld electronic device; and

FIG. 11 shows a fourth exemplary means for securing the portable charging device of FIGS. 3 to a handheld electronic device.

### DESCRIPTION OF EMBODIMENTS

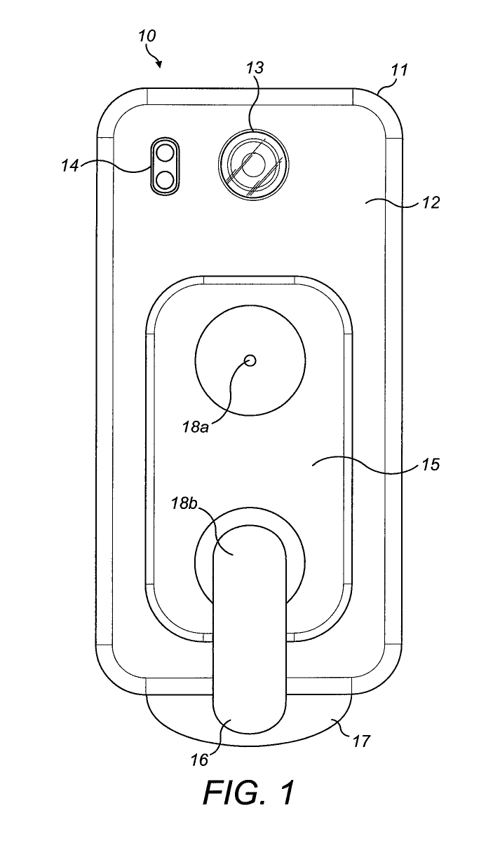

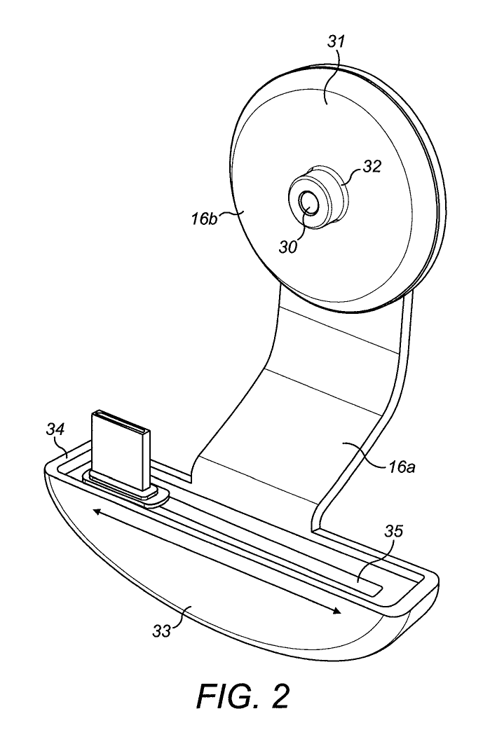

FIGS. 1 and 2 show an exemplary portable charging device according to a first embodiment of the present invention. In this embodiment, the handheld electronic device is a mobile telephone handset 10 having a casing 11 within which a battery (not shown) may be arranged. The handset 10 has a front face (not shown) on which various means for the user to interact with the handset are arranged. Such means are well known in the art of mobile telephone handset manufacture and may comprise a display screen, one or more buttons, a touch screen, a microphone, a speaker or any other means for the user to interact with the handset. The mobile telephone handset also has a rear face 12 which is substantially free of means for the user to interact with the handset. This rear face 12 may have one or more localised functional elements such as camera lens 13 or camera flash 14. Other examples of such localised functional elements include a speaker or speakers, a fold-out member suitable for use as a stand, a power button, a volume control button, or any other localised feature providing a specific function. Such handsets are known to those skilled in the art and are therefore are not described in further detail.

The handset 10 has a charging port (not shown) which is used to recharge the internal battery that is contained within the housing 11. In FIG. 1, the handset 10 is of the type which has a charging port at the bottom edge of the handset 10.

Detachably mounted to rear face 12 is a portable charging apparatus, which in the present exemplary embodiment comprises a power supply unit which in this embodiment is a battery 15 contained in a casing, a connector 16 and a plug section 17 containing means for electrically interfacing with the charging port located on the bottom edge of the handset 10 in order to charge the battery of the handset 10. In the present embodiment, plug section 17 is permanently fixed to connector 16, although alternatively plug section 17 may be detachably secured to connector 16 by means such as a clip, or pin. Connector 16 and plug section 17 are arranged to be in electrical communication with each another.

Battery 15 may be a single use battery or a rechargeable battery of a type commonly known in the art, such as a lithium-ion, nickel-metal hydride or lithium-ion polymer (LIPO) battery. In the present embodiment, battery 15 has a profile that is smaller than that of the mobile telephone handset 10, in order to prevent it from increasing the handset's footprint whilst in use. In the present embodiment, battery 15 is positioned on rear face 11 so that it does not obstruct any functional elements of the handset, such as camera lens 12 or camera flash 13.

In the case that battery 15 is rechargeable, it will include a charging port on one face or edge that will allow it to be recharged via a mains electrical supply. The charging port can be one of any number of charging port types known to the skilled person, such as a mini-USB port.

Battery 15 preferably includes means for indicating to the user when it is running low on charge, such as an LED or plurality of LEDs. Battery 15 preferably includes short circuit protection, overcharge protection, discharge protection and an auto-shutdown functionality, means for implementing all of which are well known to the skilled person. Battery 15 may also include means for detecting when the device it is charging is fully charged and further may stop supplying current to the device once this is detected. Further battery 15 may include means for varying the charge current and voltage to suit the charging characteristics (e.g. current draw, voltage and other related restrictions known to those skilled in the art) of the particular handset it is charging. Other so-called ‘intelligent’ operational features and protective mechanisms of the type known in the art, such as autodetecting voltage level for charging, may also be provided.

It will be apparent to the skilled reader that battery 15 may be exchanged for other types of power supply units such as a solar charging unit, or kinetic charging unit.

In the present embodiment, battery 15 is provided with two terminals 18a and 18b spaced apart from one another, both of which are suited for electrically connecting connector 16 to battery 15. It will be appreciated, however, that any number of individual terminals may be provided. Each terminal may be set into a recess in the battery shaped to accommodate the profile of connector 16. The terminals 18a,18b are spaced such that connector 16 can be positioned to allow plug section 17 to come into contact with any part of the perimeter of the mobile telephone handset 10.

As shown in more detail in FIG. 2, the connector 16 comprises a strap 16a having a thermoplastic elastomer (TPE) jacket covering one or more strips of electrically conductive material arranged to transmit electrical current along the length of strap 16a. In one embodiment two electrically conductive strips are provided, one providing a ground connection and the other a supply voltage connection.

Connector 16 also has a push fit connector 16b having a single electrical pin contact 30 centered on a back plate 31. Strap 16a is suited for providing an electrical connection between the battery and the handset 10 (shown in FIG. 1). It retains its own shape without requiring additional supporting means, yet is able to flex when put under pressure. In this way in can be considered to have resilient properties. However, the strap is rigid. The skilled reader will understand that strap 16a may comprise materials other than those described above and still provide this capability.

Plug section 17 comprises a semi-circular rubber outer casing 33 containing a plug 34 set into a recess having a track 35. Plug 34 is in electrical communication with strap 16a and is able to interface with a charging port on an edge of handset 10, in order to charge the internal battery of handset 10. In the present embodiment, plug 34 is arranged to be slidable along the length of track 35. The plug 34 extends in a first direction away from the planar surface of the outer casing 33 on which the track 35 is positioned and is slidable in a traverse direction. Alternatively, plug section 17 is able to move whilst plug 34 is secured in place and therefore the plug section is capable of being moved relative to the plug 34 when the plug 34 is coupled to the charging port of the handset 10.

In an alternative embodiment, the recess is wider than plug, such that plug is able to slide both across the width of and along the length of the track.

In the present embodiment, plug 34 is a micro-USB (universal serial bus) jack, although other suitable power jacks may be used.

In the present embodiment, plug section 17 is permanently attached to a distal end of strap 16a to the push fit connector 16b such that the plug section 17 and the strap 16a may be considered to be a single unit. It will be appreciated that the strap could be detachably secured to plug section 17 using push fit means similar to connector 16b and pin 30, such that plug section 17 can easily be swapped with an alternative plug section containing a different type of plug suited for use with a different handheld electronic device. Furthermore, plug section 17 may be permanently or detachably secured to strap 16a using means that allow plug section 17 to rotate relative to strap 16a. In all of these embodiments, the means attaching plug section 17 and strap 16a allow electrical communication therebetween.

Pin 30 is suited for coupling to either of battery terminals 18a or 18b in order to form an electrical connection between either terminal and strap 16a. Pin 30 is inserted into terminals 18a or 18b by aligning it appropriately and then applying pressure to back plate 31. A notch or groove 32 may be provided in pin 30 to secure it in place once inserted into terminal 18a or 18b, such that pin 30 will not disengage from terminal 18a or 18b accidentally during use. This allows strap 16a to be securely and reliably mechanically connected to battery 15 and guards against accidental disconnection that may occur when the handset is in transit or use.

Pin 30 is designed to be inserted into and removed from terminals 18a or 18b many times without significant wear. In the present embodiment, protective rubber sheaths are provided around pin 30, back plate 31 and battery 15 in order to minimise wear through use, as well as provide protection against the external environmental, e.g. rain water.

In the present embodiment, when the battery 15 is not secured to the handset 10, connector 16 is able to rotate freely about the axis of pin 30, such that plug section 17 can readily be brought into contact with any edge of handset 10. Furthermore, the connector 16 is an arm which extends away from the body of the battery 15 in a rectilinear direction when the pin 30 is coupled to the battery terminals 18a,18b.

Handset 10 is charged by the portable charging device of the above embodiments according to the following procedure. Battery 15 is mounted on rear face 11 of handset 10, where handset 10 has a charging port located at a point on one edge. Plug 34 is inserted into this charging port, causing plug section 17 to become flush with the edge of handset 10. Preferably plug section 17 does not contact the edge of the handset, but sits parallel to the edge a short distance (around 0.5-2.5 mm) from it. Plug section 17 is then moved along the length of the edge until it is positioned according to the user's wishes, where it is preferably located such that the full length of plug section 17 is facing the edge of the handset 10 so that the increase to the footprint of handset 10 is minimised. The movement of plug section 17 is facilitated by the slidable nature of plug 34.

Once plug section 17 is in position, connector 16 is electrically connected to battery 15 by inserting pin 30 in one of terminals 18a or 18b, where the terminal closer to the point on the handset's edge at which the charging port is located is selected. Connector 16 may be rotated about the axis of pin 30 or plug section 17 may be further slidably moved in order to position connector 16 appropriately, for example so that that strap 16a does not obscure camera lens 13. If plug section 17 is arranged to be rotatable with respect to strap 16a, plug section 17 may be rotated about the means securing it to strap 16a in order to bring it parallel or substantially parallel with the edge of handset 10.

Once connected to the battery 15, connector 16 and plug section 17 can remain in place until the user has charged their handset 10. During charging the user is free to use all functionality of their handset 10 that would be available if the user was charging the internal battery of the handset 10 using a conventional mains power supply. Once charging is complete, the user can detach connector 16 from terminal 18a or 18b by pulling it free and can remove plug 34 from the charging port of handset 10.

Optionally, a recessed push button may be provided on the housing of battery 15, which the user depresses to start and/or stop charging.

In an alternative embodiment (not shown), battery 15 is a rechargeable battery having a charging port located on an edge or face which is accessible whilst it is mounted to handset 10. In this embodiment, battery 15 can be recharged whilst mounted to handset 10, or alternatively can be detached from handset 10 in order to be recharged.

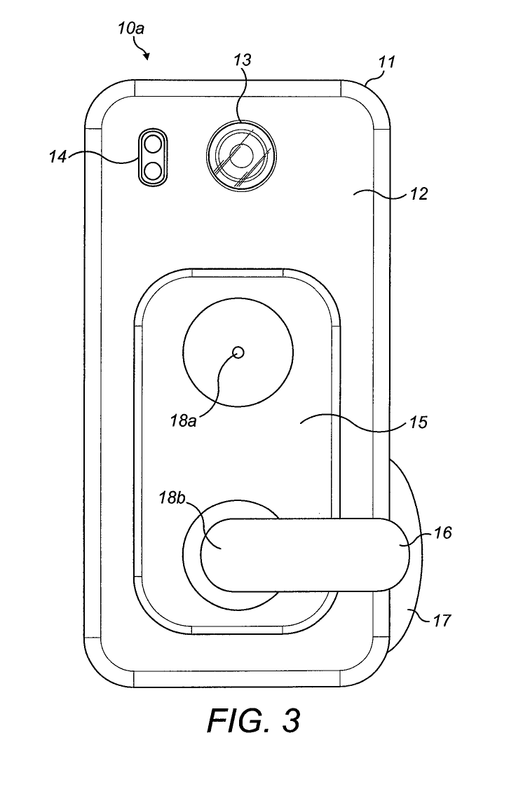

Referring to FIG. 3, another type of handset to that of FIG. 1 is shown. Handset 10a is similar to the handset 10 of FIG. 3 except that handset 10a has a charging port positioned at a different location to the charging port in FIG. 1. In this handset 10a, the charging port (not shown) is located on a side edge of the handset 10a (rather than the bottom edge). All other features of the handset 10a are the same as that in FIG. 1 and are therefore not described here. As it apparent from FIG. 3, the connector 16 is mounted to the battery 15 in a different orientation with respect to the battery 15 compared to FIG. 1 since the charging port is located on the side edge of the battery. In this embodiment, it is mounted at ninety degrees to the connector of FIG. 1. The same procedure for charging the handset 10a is carried out as is carried out for the handset 10. Since the connector 16 and therefore the plug section 17 move about a pivot point on the battery 15, it is possible to use the portable charging device with the handset 10a which has a different charging port location.

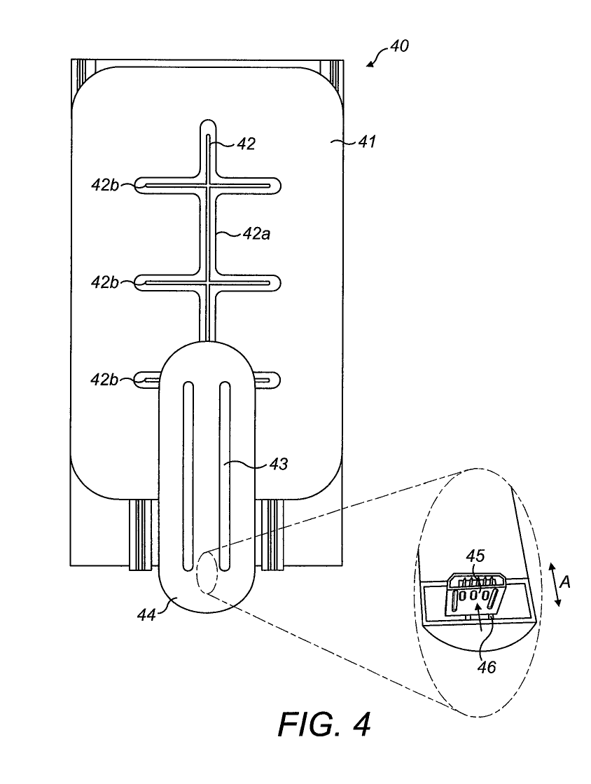

FIG. 4 shows an exemplary portable charging device 40 in accordance with another embodiment of the present invention that may be used with a mobile telephone handset such as that in FIG. 1. This embodiment differs from the preceding embodiments in that a battery 41 has a track 42 etched into one face, where this track 42 is accessible when the battery 41 is mounted to a handset (not shown). In the present embodiment, the track 42 is formed of a single straight vertical portion 42a having three horizontal portions 42b at equally spaced intervals along its length, in order to allow a connector 43 to be positioned such that a plug section 44 can come into contact with any point on the perimeter of the handset to which it is to be attached. The skilled reader will appreciate that other arrangements of tracks may be used, possibly using two or more separate tracks or combinations of terminals and tracks.

Connector 43 and plug section 44 of the present embodiment are largely identical to connector 16 and plug section 17 of the preceding embodiments. Plug section 44 comprises a housing that contains a plug 45 which is mounted on a track 46 in the plug section 44 in order to allow plug 45 to slide along the length of plug section 44 as shown by arrow A. That is, the plug 45 is capable of moving substantially parallel to the edge of the handset on which the charging port is located. This allows the plug 45 to slide away from and towards the connector 43 and to adapt to different thicknesses of handsets. The plug section 44 has a width that is the same as the width of the connector 43. In this embodiment, the plug 45 only moves within the housing in one axis with respect to the edge on which the charging port of the handset is located and this axis is transverse to the connector 43 since the end of the connector 43 that is connected to the battery 41 is capable of moving in the other axis (horizontal in the figure which is parallel to the edge of the handset).

In the present embodiment, track 42 has a rectangular cross-section and extends between 3 mm and 10 mm into the body of battery 41. Electrical connections are provided at the bottom of track 42 along its entire length, such that connector 43 is brought into electrical communication with battery 41 when fully inserted into track 42. However, it will be appreciated by the skilled reader that a track having a different cross-section and conductive arrangement is also possible.

In the case where the handset is the same as handset 10 of FIG. 1, the handset 10 is charged by the portable charging device 40 according to the following procedure. Battery 41 is mounted on rear face 11 of handset 10, where handset 10 has a charging port located at a point on one edge. Plug 45 is inserted into this charging port and subsequently a pin located at one end of the connector 46, which is remote from end where the plug section 44 is located, is inserted into track 42 at a suitable point along its length. Connector 43 may then be slid along track 42 and/or rotated about pin of the connector until it is in a desirable position, where for example camera lens 12 and camera flash 13 are not obscured. If required, the slidable nature of plug 45 within plug section 44 may be used to adapt the portable charging device 40 to the thickness of handset 10. Optionally, a recessed push button may be provided on the housing of battery 41, which the user depresses to start and/or stop charging.

In an alternative embodiment (not shown), battery 41 is covered by a rubber sheet having a track cut into it that mirrors the shape of track 42, but which is slightly narrower than track 42, such that a small portion of rubber overhangs track 42. In this embodiment, reasonable pressure is required to overcome the resistance of the rubber overhang in order to insert connector 43 into track 42 or, once inserted, to move connector 43 along track 42. This prevents connector 43 becoming accidentally disengaged from track 42, or from accidentally moving along its length whilst charging is taking place.

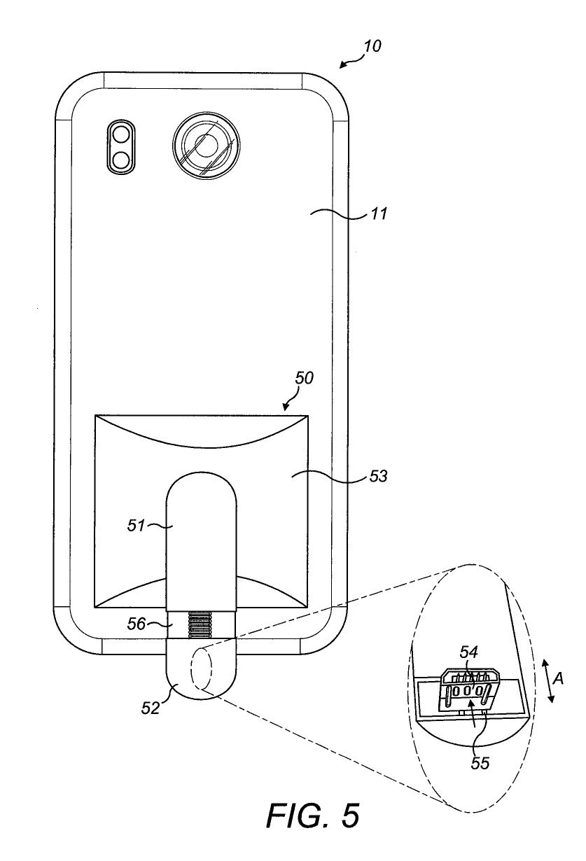

FIG. 5 shows a further exemplary portable charging device 50. In this embodiment, connector 51, plug section 52 and battery 53 are all in electrical communication with one another and are formed as one unit, such that connector 56 is permanently fixed to battery 53. Plug section 52 is identical to the plug section 44 of FIG. 4 in that it contains a plug 54 that is arranged to be slidable along a track 55 contained in plug section 52. Connector 51 features a ratchet 56 positioned at a point along its length, which is arranged to allow the length of connector 51 to be adjusted. It will be appreciated that other means suited for providing a variable length connector 56 may be provided.

In operation, plug 54 is inserted into the charging port of handset 10. The slidable nature of plug 54 and ratchet 56 co-operate to allow the position of battery 53 to be adjusted as required. Battery 53 may be secured to the handset by suitable securing means that are described later. The shape and rigidity of the housing of the connector 51 and plug section 52 which forms an “L” shape allows the power supply to be flush with the rear surface of the handset 10. The size of the battery 53 is relatively small compared to the rear surface of the handset 10. The battery 53 has a rectangular shape which is smaller than the length and width of the rear surface of the handset 10. It will be appreciated that the battery may have other shapes such as circular.

Once charging is complete, the portable charging device is removed by removing plug 54 from the charging port of handset 10. Optionally, a push button may be provided on the exterior of portable charging device 50, which the user depresses to start and/or stop charging.

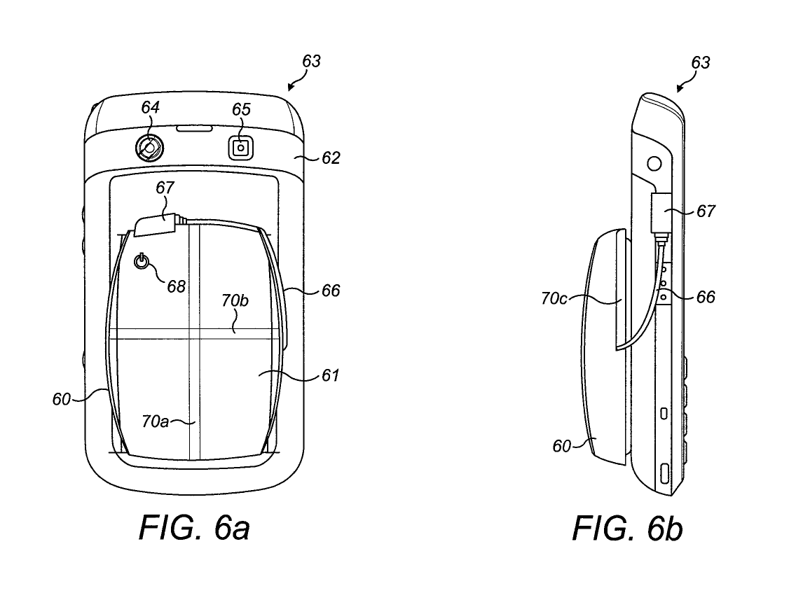

FIG. 6a shows another exemplary portable charging device 60. A battery 61 is provided in a housing that is mounted to rear face 62 of handset 63. A semi-permanent mounting means is used to secure battery 61 to handset 63. Such mounting means may comprise any of those described later in this specification. In this particular embodiment, battery 61 is mounted to handset 63 using a polyurethane gel (PU gel). The gel has good adhesive properties, and can be cleaned if it gets dirty without loosing its temporary adhesive qualities. Preferably battery 61 is mounted such that it does not obstruct any functional elements of handset 60, such as camera lens 64 and camera flash 65. Battery 61 is preferably smaller than handset 63, both in terms of thickness and area.

Attached to the battery housing is a wire 66 suitable for carrying electrical current. A casing 67 made of a lightweight durable material such as rubber or plastic is attached to the distal end of wire 66, where said casing covers a plug (not shown) suitable for electrically and mechanically connecting to both battery 61 and a charging port of handset 63. In the present embodiment this plug comprises a micro-USB connector, although other suitable connectors can be used instead.

Wire 66 should be of a length at least great enough to allow casing 67 and the plug it contains to contact any point around the perimeter of handset 63. It is noted that other such connection means could also be used in place of wire 66, such as those described hereinbefore.

Battery 61 has a charging port located on one edge, which can be connected to a mains electrical supply or other such power source via a wire, in order to allow battery 61 to be recharged. Battery 61 may have means for indicating when it requires charging and when it is being charged. In the present embodiment a single LED 68 is provided for this purpose, although other suitable means will be known to the skilled person. In particular a plurality of LEDs may be used, each conveying a specific piece of information (battery charge level, power on status etc.) Optionally a display screen is provided in the casing of battery 61 that is arranged to communicate battery status information, such as the remaining charge, to the user.

A hole in the battery housing is provided to allow external access to this charging port. When portable charging device 60 is not in use, the plug in casing 67 is preferably plugged into the battery charging port (as shown in FIG. 6a), in order to prevent environmental debris such as dirt or liquid from entering the port. Storing casing 67 in this way also serves as a means for keeping it and wire 66 secured during transit, which helps to keep the overall arrangement compact and to prevent accidental damage to these components.

Battery 61 can be recharged when mounted on handset 63, or as an individual standalone unit. Additionally battery 61 can be charged whilst itself charging handset 63.

Preferably, the housing of battery 61 is provided with a plurality of grooves 70a, 70b, 70c. Grooves 70a, 70b are located on a surface of the housing of the battery 61 on the other side of the housing to the surface connected to the housing of the handset 63. Any number of grooves can be provided to form different shapes (eg. Star shaped). A groove 70c is provided at an intermediate portion across the thickness of the perimeter of the battery housing, as shown in FIG. 6b. In the particular embodiment shown, groove 70c extends along only part of the perimeter of the housing, but alternatively it may extend around the entire perimeter of the housing. A plurality of grooves may also be provided, spaced across the thickness of the housing. Grooves 70a,70b,70c preferably comprises a semi-circular profile having a diameter slightly larger than that of wire 66, such that wire 66 fits snugly into grooves 70a,70b,70c.

In use, battery 61 is mounted to handset 63 by a suitable mounting means, as discussed herein. The plug contained in casing 67 is removed from the battery port in which it is stored and wire 66 is removed from groove 70c and the plug is plugged into the charging port of handset 63. At least part of the wire may be inserted into grooves 70a and/or 70b depending on where the charging port of the handset 63 is located. This keeps the wire snugly positioned on the battery casing and avoids flying wires extending from the battery housing when the handset 63 is being charged. Handset 63 is then charged. During handset charging, battery 61 may itself be plugged into a mains supply or other power source, if one is available, without affecting the charging of handset 63. Optionally, a recessed push button may be provided on the housing of battery 61, which the user depresses to start and/or stop charging.

Once charging is complete, as may be indicated by an LED or other such indicating device located on the casing of battery 61, the plug in casing 67 is removed from the charging port of handset 63 and returned to the charging port of battery 61, preferably such that wire 66 is returned to groove 70. Portable charging device 60 may be left mounted to handset 63, or may be removed.

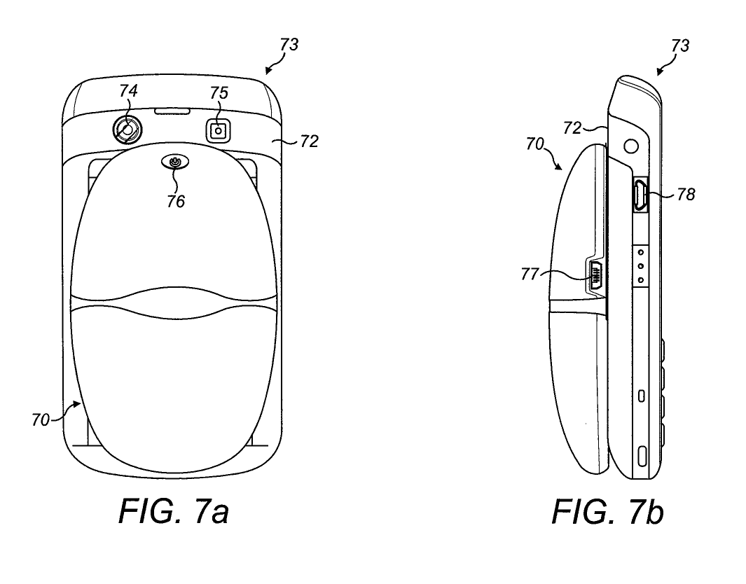

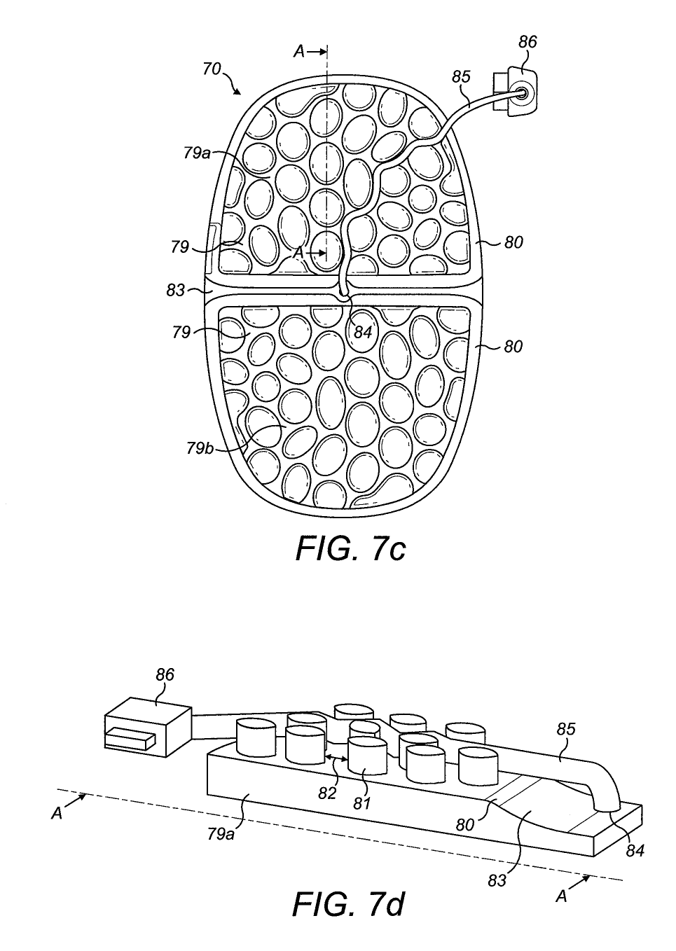

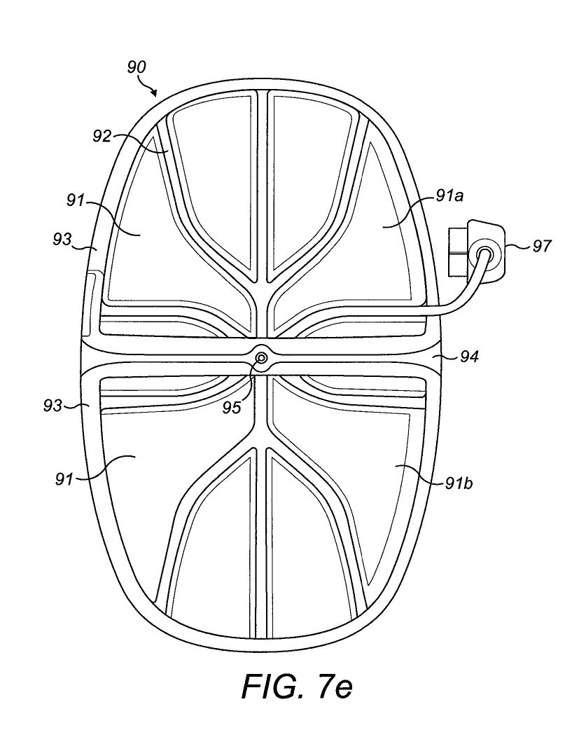

In a modification, wire 66 self-retracts into the body of the housing via a hole of a diameter just larger than that of the wire, where the hole is provided at a point on the perimeter of the housing. FIGS. 7a-7d show yet another exemplary portable charging device 70. Referring first to FIG. 7a, a battery 71 is provided in a housing that is mounted to rear face 72 of handset 73. In the present case, battery 71 is a rechargeable battery. A semi-permanent mounting means is used to secure battery 71 to handset 73. Such mounting means may comprise any of those described later in this specification. In this particular embodiment, as in the embodiment of FIGS. 6a and 6b, battery 71 is mounted to handset 73 using a polyurethane gel (PU gel). Preferably, battery 71 is mounted such that it does not obstruct any functional elements of handset 70, such as camera lens 74 and camera flash 75. Battery 71 is preferably smaller than handset 73, both in terms of thickness and area.

In the present embodiment, battery 71 is provided with a single LED 76 to indicate when it is in use. The skilled person will recognize that LED 76 may be replaced with other means suitable for conveying this or other information to the user. In particular, a plurality of LEDs may be used, each conveying a specific piece of information (battery charge level, power on status etc.) Optionally, a display screen is provided in the casing of battery 71 that is arranged to communicate battery status information, such as the remaining charge, to the user.

FIG. 7b is a side view of FIG. 7a, showing portable charging device 70 mounted to rear face 72 of handset 73. A charging port 77 is provided on the edge of portable charging device 70, to allow it to be plugged into a mains supply for recharging. The charging port 78 of handset 73 is also shown, in this case on one edge of handset 73.

As shown in FIG. 7b, the profile of the battery housing is preferably curved to allow the portable charging device 70 to be held comfortably by the user when it is mounted in place.

FIG. 7c shows the base 79 of portable charging device 70. Base 79 is divided along the minor axis of portable charging device 70 into two base portions 79a, 79b of approximately equal area. Other arrangements having two base portions of differing area are also within the scope of the present embodiment. The extent of each base portion is defined by a boundary 80, with each base portion having its own boundary. In the present embodiment boundary 80 is formed from a thermoplastic elastomer (TPE), although other suitable materials known to the skilled person are within the scope of the present embodiment.

First base portion 79a contains a sheet of a lightweight and durable material. In the embodiment of FIGS. 7a-7d the sheet is made of a thermoplastic elastomer (TPE), but other plastics, rubbers or rubber-plastic compounds may be used.

As shown in FIG. 7d a plurality of substantially oval shaped projections 81 extend from the sheet to form raised portions, such that numerous channels are formed via the gaps 82 therebetween. Preferably the projections 81 are spaced apart such that the gaps 82 formed between them are of a width in the range of 3-6 mm. The spacing between each adjacent pair of projections may be substantially the same as all others or, as shown in FIGS. 7c and 7d, the spacing may be varied. The extent of each projection 81 is such that each projection 81 extends out beyond the plane of base 79. Preferably each projection extends a distance in the range of 3-6 mm. In addition the projections all preferably extend substantially the same distance beyond the plane of base 79.

In the present embodiment projections 81 have a cross-sectional area which does not vary along their length. As an alternative projections 81 may be tapered towards the base, such that the cross-sectional area of the base of each projection is less than that of the tip. The tapering may be uniform or non-uniform along the length of each projection. Preferably projections 81 are tapered such that the distance between adjacent projections is less than the width of a wire at the top but greater than or equal to the diameter of a wire at their base.

The combined area of first base portion 79a and second base portion 79b is just less than the total surface area (or footprint) of base 79 of portable charging device 70. The balance is made up of a channel 83, which in the present embodiment is formed between the boundaries of the first and second base portions along the minor axis of portable charging device 70. Other positions of channel 83 are within the scope of the present embodiment. In addition alternative arrangements, such as may readily be contemplated by the skilled person upon consideration of this embodiment, defining for example only one base portion, or a plurality of base portions each having one or more channels therebetween, or no channel at all, are also within the scope of the present invention.

Channel 83 is recessed into base 79 and contains a hole 84, from which a wire 85 protrudes. Hole 84 allows wire 85 to penetrate the housing of portable charging device 70 in order to be brought into electrical communication with battery 71. Wire 85 may self-retract into hole 84. Preferably channel 83 is recessed an amount greater than the diameter of wire 85, such that wire 85 can lie flat in channel 83 without extending beyond the plane defined by the extents of projections 81. Channel 83 is also preferably of a width greater than the diameter of wire 85, such that wire 85 may fit snugly into channel 83 when laid flat along it. Wire 85 is preferably of a length in the range of 35-80 mm.

Attached to the distal end of wire 85 is a plug 86, suitable for mechanically interfacing with and electrically connecting to the charging port of handset 73. In the present embodiment plug 86 is a micro-USB (universal serial bus) jack, although other suitable power jacks may be used.

In the present embodiment second base portion 79b is identical to first base portion 79a except that, where first base portion 79a has projections 81, second base portion 79b has a plurality of substantially oval shaped recesses. As an alternative, second base portion 79b may be identical to first base portion 79a. As a further alternative, second base portion 79b may contain projections like those in first base portion 79a, but these projections may be distributed differently across the area of second base portion 79b. These projections may also be spaced differently to those in first base portion 79a, such that they define a different channel width or widths to those defined by the projections in first base portion 79a.

First and second base portions 79a, 79b are covered with an adhesive material (such as the polyurethane (PU) gel described previously) that is suitable for detachably mounting portable charging unit 70 to rear face 72 of handset 73, as shown in FIG. 7a. In the present embodiment only the upper surface of each projection 81 is covered with adhesive, but alternatively the entire area of first and second base portions may be covered with adhesive

The portable charging device 70 of the fifth embodiment is used as follows. Before mounting portable charging device 70 to handset 73, the user places wire 85 along an arbitrary path in gaps 82 between projections 81 in first base portion 79a or, if projections 81 are also present in second base portion 79b, along an arbitrary path in either of first or second base portions 79a, 79b. The path is chosen such that plug 86 is able to interface with charging port 78 of handset 73. Preferably the path is chosen such that all or nearly all of wire 85 is placed in gaps 82 between projections 81, so that the length of wire extending outside of the footprint of portable charging device 70 is minimized. This keeps the overall arrangement as compact as possible, as it prevents excess lengths of wire extending beyond the portable charging device and/or handset when the portable charging device is in use. This also minimizes the chance of the user finding wire 85 to be an inconvenience if they use their handset whilst it is being charged, as well as minimizing the risk of wire 85 being snagged on an object and causing plug 86 to become dislodged from handset 73 during charging.

In embodiments where the entire base 79 is covered in adhesive, the user applies pressure at intervals along the length of wire 85 to cause it to be stuck in place. In alternative embodiments where only the upper surface of each projection 81 is covered in adhesive, it is preferable to provide projections 81 having the tapered profile described previously. In this case the user is required to apply pressure along the length of wire 85 in order to force it into gaps 82 between projections 81, as the distance between the tops of adjacent projections 81 is less than the diameter of wire 85. The narrower gaps between the tops of adjacent pairs of projections 81 serve to secure wire 85 in place and prevent it from becoming dislodged.

Once wire 85 is fully secured, the user mounts portable charging device 70 onto rear face 72 of handset 73, as shown in FIGS. 7a and 7b, to which it is secured by the adhesive covering base 79 and/or projections 81. Plug 86 is then inserted into charging port 78 of handset 73 in order to commence charging. LED 76 may light up or change colour to indicate charging has begun. Optionally charging may be initiated or ceased by the user depressing a recessed push button provided on the exterior of portable charging device 70.

Optionally portable charging device 70 may be itself charged via charging port 77 whilst it is mounted to handset 73. Portable charging device 70 can be used to charge handset 73 whilst itself being charged. To charge portable charging device 70, a plug connected to a mains supply is inserted into charging port 77, in a manner well known in the art. LED 76 may indicate that portable charging device 70 is being charged.

Once charging of the handset is complete, as may be indicated by LED 76, plug 86 is removed from handset charging port 78 and portable charging device 70 is removed from handset 73 by the user. Wire 85 may remain fixed in place, in order that the user can retain the configuration appropriate for the particular handset that has just been charged. Keeping wire 85 in place also allows the user to transport the portable charging device in, for example, a bag, without having wire 85 flying loose and risking being damaged.

Alternatively if charging of a second handset having a different charging port layout is required, the user pulls on wire 85 to extract it from gaps 82 between projections 81 and repositions it along a path that causes plug 86 to be appropriately positioned for charging the second handset. In this way portable charging device 70 is capable of being used, without modification to its structure, to charge many different types of handset.

An example of an alternative portable charging device 90 according to a sixth embodiment of the present invention is shown in FIG. 7e. Unlike the fifth embodiment shown in particular in FIG. 7c, in this embodiment the sheet of thermoplastic elastomer extends beyond the plane of base 91. Preferably the sheet extends a distance in the range of 3-6 mm beyond the plane of base 91.

Etched into the sheet is a network of interconnected channels 92, forming a branch-like structure. Each channel preferably has a width and depth in the range of 3-6 mm. More preferably each channel has a substantially circular cross-section, preferably having a radius in the range of 1.5-3 mm. In the present embodiment first and second base portions 91a, 91b have an identical channel network 92, but alternatives having different network structures in each base portion are also within the scope of the present invention. In addition in the present embodiment channel network 92 is symmetric about the major axis of base 91, but alternatives in which channel network 92 is asymmetric may also be contemplated by the skilled person.

As in the fifth embodiment shown in FIG. 7c, first and second base portions 91a, 91b are each enclosed by separate boundaries 93 and a channel 94 is defined along the minor axis of base 91 between the boundaries of the first and second base portions 91a, 91b. As in the embodiment of FIG. 7c, a hole 95 is provided in the center of channel 94 out of which a wire 96 extends having a plug 97 at its distal end. This arrangement is not described in further detail here, as it is identical to that described in respect of FIG. 7c.

In the embodiment of FIG. 7d all of base 91 save channel network 92 is covered with an adhesive material, such as polyurethane (PU) gel described previously. As an alternative the entirety of base 91 may be covered with adhesive.

Portable charging device 90 of FIG. 7e is used in substantially the same way as portable charging device 70 of FIG. 7c, as described earlier. In particular instead of the user securing the wire in gaps 82 between projections 81, the user instead secures wire 96 in the branch of channel network 92 which results in plug 97 being positioned appropriately to interface with handset charging port 76. The position of each branch of channel network 92 is preferably chosen to give the user maximum flexibility in this regard, so that all manner of handsets can be charged by portably charging device 90. If multiple branches of channel network 92 allow plug 97 to contact handset charging port 76, preferably the branch resulting in the minimum length of wire 96 extending beyond the footprint of portable charging device 90 is selected.

Having presented several exemplary portable charging devices, means for securing these portable charging devices to handset 10 will now be described in detail. It should be appreciated that these means are suited for all described embodiments of the present invention which incorporate securing means.

FIG. 7 shows a first securing means suited for use with the portable charging apparatus. In this particular example, the battery is the same as battery 15 of FIG. 1. A magnetic plate 100 is provided having a profile substantially identical to that of battery 15. One face of magnetic plate 100 is covered with an adhesive sheet, protected by a plastic covering 101. When using this first securing means, protective plastic covering 101 is peeled off magnetic plate 100 in order to expose the adhesive sheet. Magnetic plate 100 is then secured onto rear face 11 of handset 10 in the desired location by application of pressure, preferably avoiding any functional elements such as camera lens 12 or camera flash 13.

Once magnetic plate 100 is secured, battery 15 is brought into contact with magnetic plate 100 and is secured there by the magnetic force exerted by the plate. In order to be receptive to this force, battery 15 may be covered in a thin plating of a ferromagnetic material such as mild steel. Alternatively, the casing of battery 15 may itself be constructed from a ferromagnetic material such as mild steel. As a further alternative, a second magnetic plate identical to magnetic plate 100 may be provided to fix to battery 15, such that the magnetic force between the two plates secures battery 15 in place. Securing battery 15 by any of the aforementioned means ensures that battery 15 is easily and readily detached from handset 10, but secure enough that it will not accidentally detach during charging.

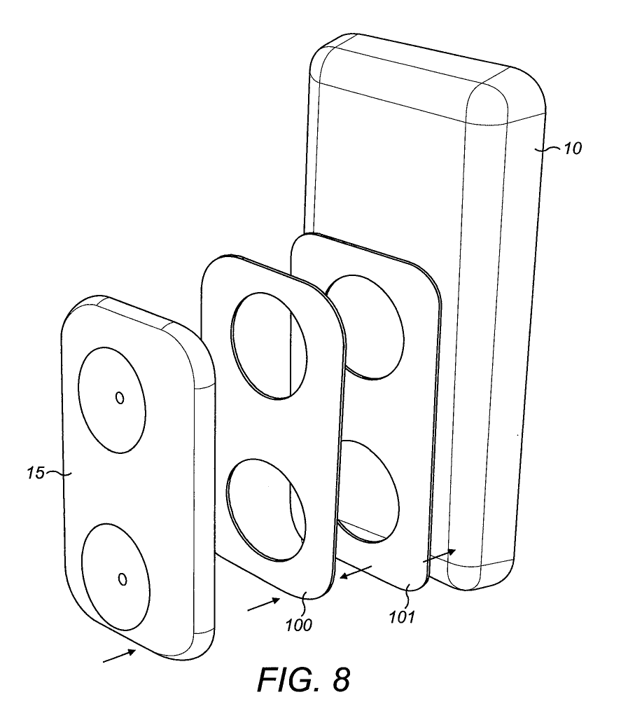

FIG. 8 shows a second securing means suited for use with the portable charging apparatuses described hereinbefore. A frame 110 having a flat central portion of the same shape and size of battery 15 is provided, such that battery 15 can be mounted on this central portion. Battery 15 may be permanently or semi-permanently mounted to frame 110 using any suitable adhesive means. Alternatively, battery 15 may form part of frame 110, in place of the flat central portion. Frame 110 is made of a lightweight, durable material such as plastic and may be covered in a rubber outer coating for protection.

Branching out from the central portion of frame 110 are four arms 111, each arm being located at a corner of the central portion and extending in the plane of frame 110 in a direction such that, when the present securing means is positioned on handset 10, each arm will contact the edge of handset 10 at a corner. Typically it has been found that an arm extending at an angle of approximately 45 degrees from the vertical is appropriate, although it will be appreciated that other angles may be used.

Arms 111 are formed of a flexible material which is sufficiently rigid to retain its own shape but which will allow arms 111 to bend back on themselves out of the plane of frame 115, preferably to a maximum extend of approximately 45 degrees. The material should be chosen such that it allows repeated such bending without damage. Suitable materials will be readily known to the skilled person and may include thermoplastics.

At the end of each of arms 111 is a securing portion 112 comprising a hollow cylinder having its axis in the direction substantially perpendicular to the extension of arms 111. The side of the cylinder which faces arm 111 is removed, such that the combination of arm 111 and securing portion 112 forms a hook-like structure. The cylinder has a length slightly greater than the thickness of handset 10, such that it can hook onto the edge of handset 10 securely. An elasticated region (not shown) may be provided at an intermediate portion along the length of each cylinder, in order to allow it to vary in length. This enables frame 110 to incorporate devices of various different thicknesses. Securing portion 112 is made of a lightweight durable material such as plastic and may be covered in a rubber outer coating for protection.

The length of arms 111 is chosen such that, when the present securing means is positioned on handset 10, each hook portion 112 is able to be secured to a corner of handset 10. To accommodate multiple devices of different sizes, a ratchet may be provided (not shown) at an intermediate portion along the length of arms 111 so that they are adjustable in length.

The present securing means is used as follows. Arms 111 are bent back upon themselves to a maximum extend of approximately 45 degrees. Frame 115 is then positioned parallel to rear face 11 of handset 10 such that the central portion of frame 115 is approximately aligned with the center of handset 10. Each of arms 111 is then bent forwards in turn, into the plane of frame 115, until each hook portion 112 is hooked around a corner of handset 10. Once secured, battery 15 is used to charge handset 10, using any portable charging apparatus according to the present invention. When charging is complete, the steps above are reversed in order to remove the present securing means from handset 10.

The skilled reader will appreciate that other arrangements, positions and numbers of arms could be provided.

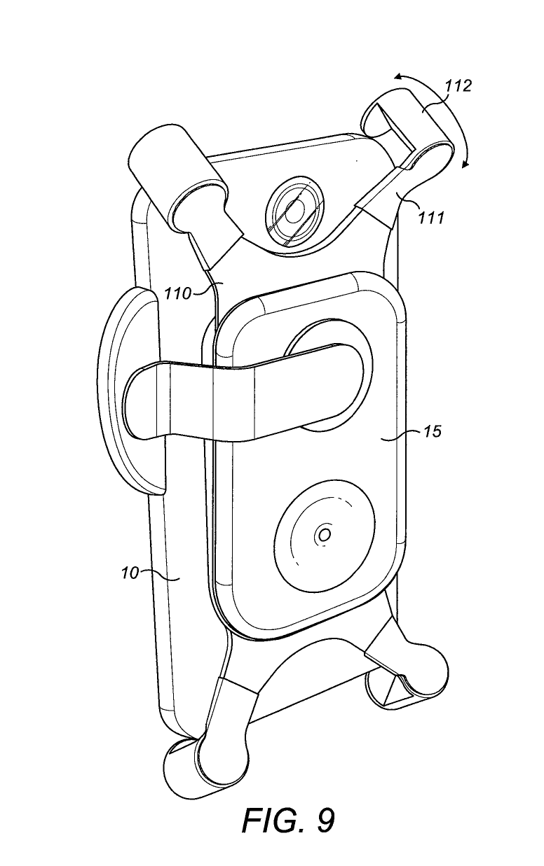

FIG. 9 shows a third securing means suited for use with the portable charging apparatus of the present invention. A plate 120 is provided having a profile similar to that of a battery 150. Two straight rails 121 are provided on a surface of plate 120 and two straight grooves 122 designed to co-operate with rails 121 are provided on a surface of battery 150. Plate 120 and rails 121 can be manufactured from any lightweight, durable material such as plastic.

A cross-sectional view of rails 121 and grooves 122 is shown in FIG. 8a. Each of rails 121 has an ‘r-shaped’ cross-section, extending in a first direction perpendicular to the length of rails 121 and then in a second direction which is perpendicular to both the first direction and the length of rails 121. Grooves 122 are also ‘r-shaped’, such that they co-operate with rails 121. This type of cross-section prevents battery 150 moving away from the plane of handset 10 during charging. The skilled reader will appreciate that other rail/groove configurations having one, two or more than two rails and grooves that achieve this object could be provided.

Grooves 122 begin at one edge of battery 150 and extend along the majority of the length of battery 150, stopping short of the opposing edge. A raised portion 123 may be provided on the surface of battery 150 to serve as a buffer, and the rails 121 will impact upon this buffer when battery 150 is mounted to plate 120 to indicate that battery 150 is fully mounted on plate 120. Raised portion 123 also prevents battery 150 from sliding too far along rails 121.

Rails 121 should be slightly wider than grooves 122, such that reasonable pressure is required to mount battery 15 on plate 120. Alternatively, rails 121 may be narrower than grooves 122 but covered in a rubber coating, such that the combination of rails 121 and the rubber coating is slightly wider than grooves 122. Either arrangement ensures adequate frictional force exists between rails 121 and grooves 122 in order to secure battery 150 in place once mounted to plate 120.

Plate 120 is detachably secured to rear face 11 of handset 10 using temporary securing means such as polyurethane gel (PU gel). The gel has good adhesive properties, and can be cleaned if it gets dirty without loosing its temporary adhesive qualities. Preferably, plate 120 is secured to handset 10 at a location which does not affect the operation of functional elements such as camera lens 12 or camera flash 13. In addition, the location of plate 120 is preferably chosen such that battery 150 is proximal to the charging port of handset 10. Further, the orientation of plate 120 is chosen such that rails 121 allow battery 150 to be mounted in an orientation in which the plug of the battery can reach the charging port of handset 10. The skilled person will appreciate, however, that this may not be a concern when securing a portable charging device according to embodiments which have a rotatable connector, such as that shown in FIG. 1.

Once plate 120 is secured, battery 150 is mounted on plate 120 by aligning rails 121 with grooves 122 and providing reasonable pressure to battery 15 such that rails 121 slide into grooves 122. Pressure is applied until the entire length of rails 121 is inside grooves 122, possibly indicated by the resistance provided by buffer 123. Once battery 150 is secured in this manner, charging may begin. To remove battery 150 once charging is complete, the opposite process is applied.

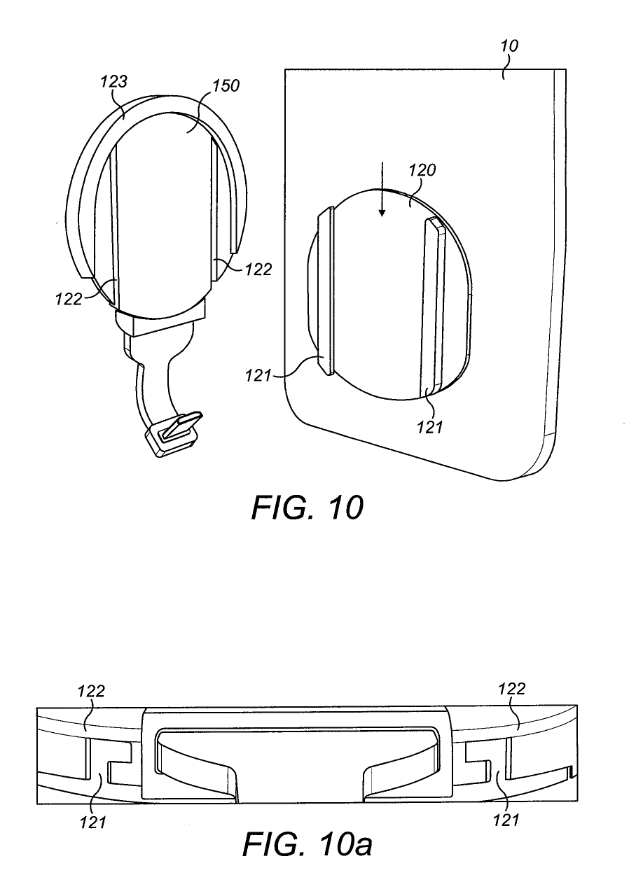

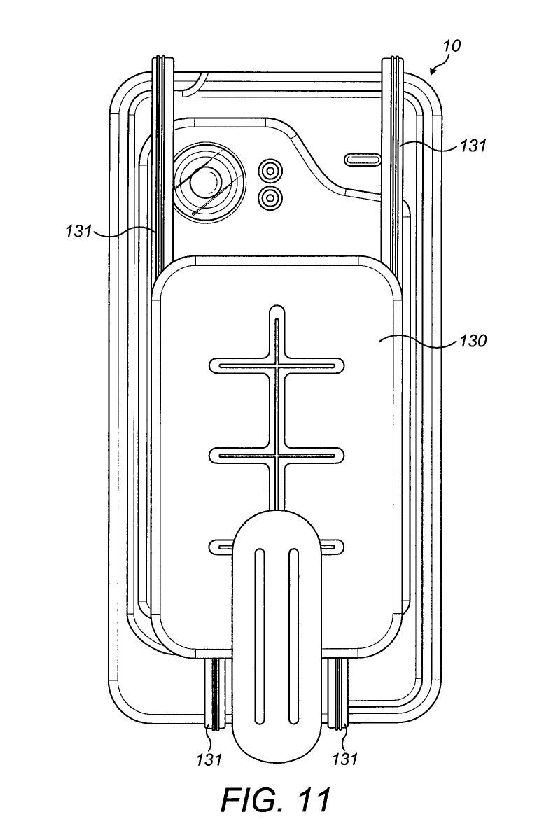

FIG. 10 shows a fourth securing means suited for use with the portable charging apparatus and particularly the portable charging device of FIG. 3. Reference is therefore made to the battery casing 41 as shown in FIG. 3. Fixed to battery casing 41 are four straps 131 formed of a lightweight durable materials such as plastic. Straps 131 may be permanently or detachably fixed to battery casing 130. Straps 131 are arranged in pairs, with one pair being fixed to the corners of one end of battery casing 131 and the other pair being fixed to the opposite end of battery casing 131 at an intermediate position between the corners of this opposite end. Preferably straps are arranged symmetrically about the central axis of battery casing 131. It will be appreciated, however, that other such arrangements are possible.

Straps 131 extend in the plane of battery 41 in the direction parallel to the length of battery casing 130. The end of each strap 131 is formed into a hook-shaped portion, with the bend of the hook being of a suitable size and shape to accommodate the thickness of handset 10b.

Straps 131 may feature a ratchet (not shown) at an intermediate portion along their length, in order to allow their length to be adjusted to accommodate portable electronic devices of different sizes.

In use, handset 10b is positioned within the hook-shaped portions of straps 131, such that straps 131 secure battery casing 130 to handset 10b. The length of straps 131 may be adjusted using ratchets, if provided, in order to secure battery casing 41 to handsets of different sizes.

The above embodiments therefore provide a portable charging device that provides recharging of the internal battery of a handheld electronic device. The portable charging device is universal in that it is suited for use with a variety of handheld electronic devices having different power jack and button layouts, which does not prevent the user from using any of the functionality of their device whilst it is being charged. The universal portable charging device does not extend significantly beyond the edges of the handheld electronic device when in use and does not entirely encase the handheld electronic device. Therefore, it allows the user to use, handle and store their device easily whilst it is being charged. The portable charging device can be semi-permanently attached to a handheld electronic device providing an overall compact device which does not significantly increase the thickness of the handheld electronic device. It can stay connected to the electronic device while in use and is hidden behind the electronic device so the electronic device and portable charging device can be considered a single product.

Although the above embodiments have been described separately, it will be appreciated by those skilled in the art that they are not mutually exclusive and different aspects of the embodiments may be combined and certain features may be dispensed with when combining embodiments without departing from the scope of the invention.

1. A portable charging apparatus for a handheld electronic device having a housing including an internal battery, the portable charging device comprising:
a power supply;
an electrically conductive means for providing power from the power supply, the electrically conductive means comprising a wire having a plug at a distal end for detachably connecting to a charging port of a handheld electronic device, wherein one or more channels are formed in the power supply and are arranged to accommodate the wire whilst the device is in use; and
securing means for detachably securing the portable charging apparatus to the housing of the handheld electronic device, whereby in use the portable charging apparatus is secured to an outer surface of the housing of the handheld electronic device.

2. The portable charging apparatus of claim 1, wherein the power supply has a single channel extending around its perimeter.

3. The portable charging apparatus of claim 1, wherein the power supply has a base, said base having a plurality of projections formed therein, and wherein the one or more channels are defined by the gaps between said projections.

4. The portable charging apparatus of claim 3, wherein a securing means comprises an adhesive.

5. The portable charging apparatus of claim 4, wherein the adhesive is applied only to the topmost surface of each of the plurality of projections.

6. The portable charging apparatus of claim 4 or 5, wherein the adhesive is polyurethane gel.

7. The portable charging device of claim 1, wherein the power supply is a rechargeable battery.

8. The portable charging device of claim 1, wherein the power supply comprises a charging port and the plug of the electrically conductive means is arranged to be connected to the charging port when the power supply is not in use.

9. The portable charging device of claim 1, wherein a plurality of channels are formed in the power supply.

10. A power supply for use in a portable charging device, the power supply comprising an electrically conductive means for providing power from the power supply, the electrically conductive means comprising a wire having a plug at a distal end for detachably connecting to a charging port of a handheld electronic device, wherein one or more channels are formed in the power supply and are arranged to accommodate the wire whilst the device is in use.

11. A portable charging apparatus for a handheld electronic device, comprising:
a power supply means having a power supply and at least one interface port providing an electrical connection to the power supply;
securing means for detachably securing the power supply means to a handheld electronic device; and
a connector unit comprising an electrically conductive member having a first connector for detachably electrically connecting to the handheld electronic device and a second connector for electrically connecting to the interface port of the power supply means;
wherein the second connector is mountable on the power supply means such that the connector unit is movable relative to the power supply means.

12. The portable charging apparatus of claim 11, wherein the connector unit is detachably mounted on the power supply means.

13. The portable charging apparatus of claim 11 or 12, wherein the connector unit is pivotally mounted to the power supply means.

14. The portable charging apparatus of claim 11, wherein the power supply means comprises a plurality of interface ports and the second connector is mountable to any one of the interface ports.

15. The portable charging apparatus of claim 11, wherein the interface port of the power supply means comprises at least one channel and the second connector is slidable along this at least one channel.

16. The portable charging apparatus of claim 11, wherein the connector unit comprises a housing in which the first connector is mounted, and the first connector is slidable within the housing.

17. The portable charging apparatus of claim 11, further comprising securing means for detachably securing the power supply means to a handheld electronic device.

18. The portable charging apparatus of claim 17, wherein the securing means comprise at least one of magnetic plates, adhesive, fasteners or elastic cords.

19. The portable charging apparatus of claim 17, wherein the power supply means is arranged to be secured to a major surface of the handheld electronic device.

20. The portable charging apparatus of claim 11, wherein the electrically conductive member is contained within a housing that is mechanically rigid.

21. The portable charging apparatus of claim 11, wherein the first connector is located at a first position of the electrical connector and the second connector is located at a second position remote from the first position.

22. The portable charging apparatus of claim 11, wherein the first connector is a micro-usb connector.

23. The portable charging apparatus of any of claim 11, wherein the power supply means is a battery.

24. A portable charging apparatus for a handheld electronic device having a housing including an internal battery, the portable charging device comprising:
a power supply;
an electrically conductive means for providing power from the power supply, the electrically conductive means comprising a plug for detachably connecting to an charging port of a handheld electronic device; and
securing means for detachably securing the power supply to the housing of the handheld electronic device, wherein the plug is movable relative to the power supply such that, in use, the plug can be moved into alignment with the charging port of the handheld electronic device before securing the power supply to the housing of the handheld electronic device.

25. The portable charging apparatus of claim 24, wherein the plug is movable within housing.

26. The portable charging apparatus of claim 25, wherein the plug is movable along two axes that are substantially perpendicular to each other.

27. The portable charging apparatus of claim 24, 25, or 26, wherein the plug is movable via a ratchet mechanism.

28. The portable charging apparatus of claim 24, wherein the electrically conductive means is detachably mounted on the power supply.

29. The portable charging apparatus of claim 24, wherein the electrically conductive means is pivotally mounted to the power supply.

30. The portable charging apparatus of claim 24, wherein the electrically conductive means is slidably mounted on the power supply.

31. The portable charging apparatus of claim 24, wherein the securing means comprise at least one of magnetic plates, adhesive, fasteners or elastic cords.

32. The portable charging apparatus of claim 24, wherein the electrically conductive member is contained within a housing that is mechanically rigid.

33. The portable charging apparatus of claim 32, wherein the housing is formed of thermoplastic elastomer.

34. The portable charging apparatus of claim 24, wherein the power supply means is a rechargeable battery.

35. (canceled)
